(19) United States
(12) Patent Application Publication
(10) Pub. No.: US 2008/0306827 A1
(43) Pub. Date: Dec. 11, 2008

(54) System for Registration of Commercial Transactions

(76) Inventor: Jonathan Labaton, Hertzlya (IL)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/025,733

(22) Filed: Feb. 4, 2008

Related U.S. Application Data
(60) Provisional application No. 60/899,321, filed on Feb. 2, 2007.

(51) Int. Cl. G06Q 20/00

(52) U.S. Cl. 705/16

(57) ABSTRACT

The present invention is a new use of the POS terminal and the existing communication networks for processing, registering and storing all commercial transactions regardless of payment method that when combined with an electronic lottery increases the registration of commercial transactions.

### CROSS-REFERENCE TO RELATED APPLICATIONS

This application claims priority to and benefit of U.S. Provisional Application No. 60/899,321, entitled “System for Registration of Commercial Transactions” and filed on Feb. 2, 2007.

### FIELD OF INVENTION

The invention generally relates to the use of point of sale terminals for processing commercial transactions regardless of payment method and, particularly to its combination with an electronic lottery that increases the registration of commercial activity.

### BACKGROUND OF THE INVENTION

A point of sale (POS) terminal is generally used to facilitate commercial transactions between a merchant and its customers. Typically, customers present a transaction instrument (e.g., credit card, debit card, charge card, smart card, and the like) to the merchant as payment at the time of purchase. The transaction instrument is inserted into the POS terminal and the POS terminal transmits a request for payment authorization to the financial institution associated with the particular transaction instrument. The POS terminal receives payment authorization or non-authorization for the request and the transaction is completed. However, when a customer presents cash to pay for a commercial transaction, the merchant accepts the cash and does not utilize the POS terminal. In addition, other payment methods that do not involve a credit card, debit card, charge card, smart card, gift card, and the like, also result in the POS terminal not being used.

These commercial transactions that do not involve POS terminals make it difficult to track and store information about commercial transactions, regardless of payment method.

### SUMMARY OF THE INVENTION

New use of POS terminals and of communication networks for processing, registering, and storing of commercial transactions independent of the payment method used in them, that when combined with the generation of an electronic lottery, increases the registration of commercial activity.

### BRIEF DESCRIPTION OF THE DRAWINGS

A more complete understanding of the present invention may be derived by referring to the detailed description and claims when considered in connection with the drawing FIGURE, where like reference numbers refer to similar elements throughout the FIGURE, and:

FIG. 1 illustrates a flow diagram in accordance with an exemplary embodiment of the present invention.

### DETAILED DESCRIPTION

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices. In addition, the present invention may be practiced in any number of financial transaction contexts and the exemplary embodiments relating to a system and method for registration of commercial transactions are merely a few of the exemplary applications for the invention. For example, the principles, features and methods discussed may be applied to any financial transaction application.

In accordance with an embodiment of the present invention, a new use of a POS terminal and existing communication networks, that when combined with an electronic lottery creates a method for increasing the registration, processing and storing of commercial transactions, for example, in an external server.

The present invention utilizes a device, such as a POS terminal, that is used as the tool through which all commercial transactions, no matter the payment method, are input into a computer system where transactions are processed, registered and stored for a later use.

Commercial information generated at the POS terminal is transferred to a database, such as a database that is located in an external server, through existing data networks such as telephone lines or internet connections and the like. The data is later used for commercial purposes, focused on the generation of an electronic lottery.

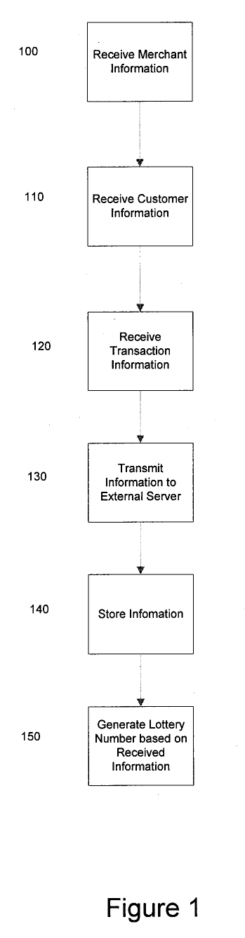

In accordance with one embodiment of the present invention, with reference to FIG. 1, a method comprises the input through the POS terminal of: (a) the merchant's identity (step 100); (b) the customer's identity (step 110); and (c) the money amount of the transaction (step 120). This information is transferred via data networks to an external server (step 130), where the information is stored and later used for commercial and/or non commercial activities.

When a payment is due, the merchant inputs into the POS terminal, the transaction's details such as merchant and customer's identity, and money amount of the transaction.

For credit card payments, the merchant slides the plastic (credit/debit card) through the card reader of the POS terminal. The POS terminal transmits the customer's ID to the System Server.

For non-credit card transactions and for card-not-present transactions, the merchant inputs into the POS terminal, a customer's identification number such as a driver license number, a national identification number, and the like. The identification number may be entered manually, or by sliding a card, such as a driver's license, through the card reader of the POS terminal.

All the registered information is then transferred via data networks to an external server where the information is processed, registered and stored (step 140). In accordance with one embodiment of the present invention, at the server, a file is created for each processed transaction.

The data stored at the server (files) is used for commercial activities focused on the generation of an electronic lottery (step 150). In accordance with another embodiment of the present information, the data is used to measure the amount of commercial activity that takes place by analyzing the information received from one or more point-of-sale terminals. For example, statistical measurements of all commercial activity, cash-based, as well as credit card and debit card based, may be conducted.

The electronic lottery is based on software that receives the data processed at the POS terminal and generates lottery numbers. In accordance with an embodiment of the present invention, the number of lottery numbers generated by the software is the result of dividing the amount of the commercial transaction by a determined denominator.

The abovementioned method rewards the registration of commercial activity into the system through the POS terminals as the possibilities to win the electronic lottery—the number of lottery numbers—is directly related to the money amount of transactions processed.

It should be appreciated that this combination of POS terminals and an electronic lottery increases the registration of commercial activity regardless of the payment method.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims.

We claim:

1. A method for registering and processing a financial transaction, comprising:
receiving, by a point-of-sale terminal, information about a merchant;
receiving, by the point-of-sale terminal, information about a customer;
receiving, by the point-of-sale terminal, a monetary amount for the financial transaction,
transmitting the merchant information, the customer information, and the monetary amount to an external server;
storing, by the external server, the transmitted information; and
generating a lottery number by utilizing the transmitted information.

2. The method of claim 1, wherein the financial transaction is a cash transaction.

3. The method of claim 1, wherein the customer information is received by sliding a credit card through a card reader of the point-of-sale terminal.

4. The method of claim 2, wherein the customer information is received by inputting a customer identification number into the point-of-sale terminal.

5. The method of claim 1, further comprising the step of measuring commercial activity by analyzing the transmitted information.
